(19) United States
(12) Patent Application Publication
(10) Pub. No.: US 2006/0114882 A1
(43) Pub. Date: Jun. 1, 2006

(54) Presence management in packet-switched networks using circuit-switched USSD signaling

(76) Inventor: James L. Mills, Frisco, TX (US)

Correspondence Address: ERICSSON INC., 6300 LEGACY DRIVE, M/S EVR C11, PLANO, TX, 75024, US

(21) Appl. No.: 11/000,292

(22) Filed: Nov. 30, 2004

(51) Int. Cl. H04L 12/66; H04L 12/56

(52) U.S. Cl. 370/352; 370/401

(57) ABSTRACT

A method of managing presence information in a packet-switched wireless communication network such as a General Packet Radio Service (GPRS) network or a Wideband Code Division Multiple Access (WCDMA) network. Instead of using the Session Initiation Protocol (SIP) to send presence update messages to a presence server in the packet-switched network, the MS/UE sends its presence information to the presence server using a circuit-switched Unstructured Supplementary Services Data (USSD) message that is sent via a USSD gateway. The USSD message includes an IP address of the presence server, and the USSD gateway extracts the IP address and forwards the presence update message to the presence server.

### BACKGROUND

The present invention relates generally to wireless communication networks, and in particular, to a packet-switched wireless communication network that utilizes circuit-switched Unstructured Supplementary Services Data (USSD) messages to carry presence information.

The Session Initiation Protocol (SIP) initiates, modifies, and terminates interactive communication sessions between users. SIP is an ASCII text-based signaling protocol similar to the Hypertext Transport Protocol (HTTP). Each communication session may include different media types such as audio and video. When initiating a communication session, SIP determines where the called user is located at the particular moment when the session is established. In this way, SIP enables personal mobility by providing the capability to reach a called party at a single location-independent address.

The SIP architecture is based on a client/server model using a request-response paradigm. The main entities in SIP are the User Agent, the SIP Proxy Server, the SIP Redirect Server, and the Registrar. The User Agents, or SIP endpoints, function as User Agent Clients (UACs) when initiating requests, and as User Agent Servers (UASs) when responding to requests. SIP intermediate servers have the capability to behave as proxy or redirect servers. The User Agent sends a registration message to the SIP Registrar, and the Registrar stores the registration information in a location service via a non-SIP protocol.

The 3rd Generation Partnership Project (3GPP) and the Internet Engineering Task Force (IETF) have adopted SIP for establishing, controlling, and maintaining real-time wireless multimedia sessions within an Internet Protocol (IP)-based framework. Since SIP is an ASCII text-based signaling protocol, SIP messages are lengthy. For example, a SIP NOTIFY message is 718 bytes, with the corresponding OK message at 276 bytes. The lengthy messages make signaling over bandwidth-limited wireless channels inefficient.

SIP is also used for session initiation and call control for Push-To-Talk-over-Cellular (PoC) services. PoC is a fast-connect, half-duplex service alternatively known as Push-to-Talk (PTT) or voice chat services. PTT applications provide two-way, one-to-one private calls and one-to-many group call services similar to a walkie-talkie service, but with a number of advantages. Subscribers can take advantage of private, direct, simultaneous radio voice connection over very wide areas, affordably and conveniently, often replacing other devices such as pagers and two-way radios. Subscribers can instantly connect to one or more receivers simply by pushing a button on their handset. Users receiving the call hear the caller's voice automatically without having to answer the call.

PoC is the official name used in the open specifications currently being developed by the Open Mobile Alliance (OMA) for this service. The PoC specifications utilize a number of existing specifications from the Internet Engineering Task Force (IETF), the Third Generation Partnership Project (3GPP), and 3GPP2 including the capabilities of the 3GPP IP Multimedia Subsystem (IMS) and the 3GPP2 Multimedia Domain (MMD) to enable IP connectivity between mobile devices. Technical specifications describing the PoC feature include the 3GPP TS 22.141 and TS 23.141. Additionally, 3GPP 24.841 specifies presence methods using the Session Initiation Protocol (SIP). All of these specifications are hereby incorporated herein by reference in their entireties.

PoC may be implemented on the IP backbone over radio technologies such as WCDMA, CDMA2000, GPRS, UMTS, and 802.11. The use of IMS and MMD adds the ability to integrate voice and data services over IP-based packet-switched networks. Two fundamental capabilities are added on top of the packet-switched domain. First is the ability to find a user via SIP to initiate a session. Second is the ability to integrate new services such as PTT. By introducing IMS and its multiple service-delivery capability, a common infrastructure for services is established, and the requirement to build a service delivery infrastructure for each service is eliminated.

“Presence” reporting is currently utilized in PoC to indicate whether a Mobile Station/User Equipment (MS/UE) is available or unavailable for PoC services. However, in the future, it is anticipated that presence reporting may also be utilized to indicate subscriber call state (i.e. busy/idle/do-not-disturb), location, current communication addresses, and the like. These additional uses for presence reporting would increase the frequency of presence update signaling because updates are sent whenever any part of the presence information changes. This creates a large burden on the network, primarily because of the long ASCII text-based SIP messages discussed above.

One solution is proposed in the paper, Sweeney et al., Efficient SIP based Presence and IM Services with SIP message compression in 1^{ST} OPIUM, Cork Institute of Technology/Adaptive Wireless Systems group (CIT/AWS), Sep. 26, 2003. In this paper, Sweeney et al. propose compressing SIP messages using a Text Compression using Cache and Blank (TCCB) approach. This solution, however, adds additional complexity and results in only modest efficiency gains in the network.

It is also noted that 3GPP 24.841, which specifies presence methods using SIP, states that other bearers besides SIP may be utilized for presence reporting, namely “WAP, SMS, etc.” However, using WAP signaling also loads the IP multimedia network, and SMS is not really suitable because SMS messages must pass through an SMS Messaging Center (SMS-C), resulting in increased latency.

### SUMMARY

In one aspect, the present invention is directed to a method of managing presence information in a packet-switched wireless communication network. The method includes sending a circuit-switched presence update message from a mobile unit to a presence server in the packet-switched network; and updating the presence information for the mobile unit in the presence server. The circuit-switched presence update message may be an Unstructured Supplementary Services Data (USSD) message that is sent via a USSD gateway. The mobile unit may be a User Equipment (UE) operating in a Wideband Code Division Multiple Access (WCDMA) network, or a Mobile Station (MS) operating in a General Packet Radio Service (GPRS) network.

In another aspect, the present invention is directed to a method of managing presence information in a packet-switched wireless communication network. The method includes sending a packet-switched presence message from a mobile unit to a presence server in the packet-switched network during initial registration of the mobile unit with the packet-switched wireless communication network. The packet-switched presence message includes presence information for the mobile unit, an identification number for the mobile unit, and an indication that the mobile unit supports circuit-switched presence reporting. The method also includes sending a packet-switched acknowledgment message from the presence server to the mobile unit in response to the packet-switched presence message. The packet-switched acknowledgment message includes an Internet Protocol (IP) address of the presence server and an indication that the presence server supports circuit-switched presence management. Thereafter, the mobile unit determines that a change in the presence status of the mobile unit has occurred, and sends a circuit-switched presence update message to the presence server. The presence information for the mobile unit is updated in the presence server, and all future presence updates are sent via circuit-switched messages. In a preferred embodiment, the circuit-switched presence update messages are USSD messages.

In yet another aspect, the present invention is directed to a USSD gateway. The USSD gateway includes means for receiving from a mobile unit, a circuit-switched USSD presence update message that includes an IP address of a presence server in a packet-switched wireless communications network. The USSD gateway also includes means for extracting the IP address of the presence server from the USSD message; and means for forwarding the presence update message to the presence server utilizing the extracted IP address of the presence server.

In still yet another aspect, the present invention is directed to a method of reporting presence information for a mobile station attached for packet-switched operation in a GPRS wireless communication network, wherein the mobile station has entered a STANDBY state. The method includes receiving by the mobile station, a page for a circuit-switched call; suspending packet-switched GPRS operation by the mobile station; and sending a circuit-switched presence update message from the mobile station to a presence server in the GPRS network, said circuit-switched presence update message including an indication that the mobile station is unavailable due to receiving the circuit-switched call. The circuit-switched presence update message may be a USSD message, and the mobile station may periodically send refresh USSD messages to the presence server during the circuit-switched call indicating that the mobile station is still unavailable. Additionally, upon ending the circuit-switched call, the mobile station may send a USSD message to the presence server indicating that the mobile station is available.

### BRIEF DESCRIPTION OF THE SEVERAL VIEWS OF THE DRAWINGS

In the following, the essential features of the invention will be described in detail by showing preferred embodiments, with reference to the figures of the attached drawings, in which:

FIG. 1 is a flow chart illustrating the steps of a method of presence reporting in a WCDMA network in accordance with the teachings of the present invention; and

FIG. 2 is a flow chart illustrating the steps of a method of sending presence updates in a GPRS network when an MS attached for packet-switched GPRS operation is paged for a circuit-switched call.

### DETAILED DESCRIPTION

The present invention is a method of presence management that greatly reduces the load on a packet-switched wireless communication network. Instead of using SIP signaling for presence management, the present invention uses circuit-switched signaling. In particular, the present invention uses circuit-switched Unstructured Supplementary Services Data (USSD) messages to carry the presence information. USSD is a circuit-switched service that allows proprietary services to be overlaid on existing mobile networks, with only generic support of the USSD mechanisms in the networks. Because USSD is a circuit-switched service and utilizes dedicated signaling connections between the terminal and network-based applications, USSD is not normally considered for use as a bearer for a packet-switched Voice-over-IP (VoIP) service.

Compared to SIP signaling or compressed SIP signaling, the present invention results in reduced signaling in IP multi-media network nodes, for both Wideband Code Division Multiple Access (WCDMA) and Global System for Mobile Communications/General Packet Radio Service (GSM/GPRS) networks. The invention also results in reduced signaling in WCDMA radio access networks. Additionally, the present invention significantly reduces message size over the bandwidth-limited air interface.

Utilizing Push-To-Talk-over-Cellular (PoC) as an example, the implementation of the present invention will now be described. In an exemplary existing PoC system, each MS having a PoC client initially registers with a PoC server using SIP signaling. Next, the MS registers with the presence server (using a SIP PUBLISH message) to indicate that it is available. The SIP PUBLISH message is sent to the presence server with an expiry time set to match the expiry time of the registration. Periodically the MS re-registers with the presence server (also with the SIP PUBLISH message), to indicate that the MS is still available for PoC services. The MS updates the presence information by sending a new SIP PUBLISH message whenever there is a change in status. At de-registration or power-off, the MS sends a PUBLISH message with the expiry time set to zero. If the MS roams out of coverage, and the time expires in the presence server, the presence server changes the availability state to “unavailable”.

In the exemplary implementation, the PoC client in the MS also requests individual or group presence information from the presence server (using the SIP operation, SUBSCRIBE NOTIFY), whenever the user selects a PoC contact menu screen on the MS. Alternatively, the presence server may automatically push this information to the PoC client whenever a change of status is detected, but this causes more signaling, much of which is unnecessary since the updates are only needed when the subscriber is viewing the contact list. Despite design efforts to reduce the volume of SIP signaling, it is estimated that, with existing presence management procedures, approximately 50 percent of the SIP signaling through the Call State Control Functions (CSCFs) (with PoC implemented) is used to maintain the presence information in the presence server.

When the user subscribes to a contact list (instead of an individual MS), the SUBSCRIBE request goes first to a Resource List Server (RLS). The RLS then propagates individual SUBSCRIBE requests to the presence server. Since the IMS core system does not know where to route SIP messages to a contact list, the group/list functionality is integrated with the presence server by naming all of the contact lists with a domain name of the RLS (e.g., contactlist_user1@presence.com). In this way, all SUBSCRIBE requests for the contact list are routed to the RLS.

The present invention modifies the client in the MS/UE to send presence updates to the presence server utilizing circuit-switched USSD messages. The presence server may be modified to receive the USSD presence updates from the MS/UE, or alternatively, to receive USSD MAP signaling sent by the HLR. Additionally, a USSD gateway is modified to receive the USSD presence updates from the MS/UE, extract an IP address for the presence server, and forward the presence update message to the presence server.

The presence server may also use USSD messages to push the group's presence status to the MS/UE. USSD signaling is much more efficient than SIP signaling over the air interface, in terms of message sizes. For example, while the SIP NOTIFY message is 718 bytes, and its corresponding OK message is 276 bytes, a USSD REGISTER (FACILITY) message is only approximately 66 bytes, including a header of 26 bytes and user data of approximately 40 bytes (including the Mobile Station Integrated Services Digital Network (MSISDN) of the UE, IP-address/port of the presence server, possibly the Signaling Point Code (SPC) of the presence server, and UE status).

Another benefit of using circuit-switched USSD messages for presence reporting is that signaling through the IP Multi-Media (IPMM) nodes is significantly reduced, because the circuit-switched signaling goes from the serving Mobile Switching Center (MSC) to the user's Home Location Register (HLR), from the HLR to the USSD gateway, and from the USSD gateway to the presence server (using either SS7 or IP). If PoC is implemented for WCDMA MS/UE's, and an MS/UE is in a state where it does not have a signaling connection, then the presence update utilizing SIP requires that a Radio Resource Control (RRC) connection be re-established, that an lu-PS signaling connection be established, and that the PDP context Radio Access Bearers (RABs) be allocated. Use of USSD improves latency because the circuit-switched update messages require only that the RRC connection and the lu-CS signaling connection be established. The RABs do not need to be allocated for the USSD update message. This also results in less signaling over the air interface.

There are similar advantages for GSM/GPRS networks, but in addition, it is noted that USSD presence updates can be made while a circuit-switched call is in-progress or when the call is being initiated or terminated.

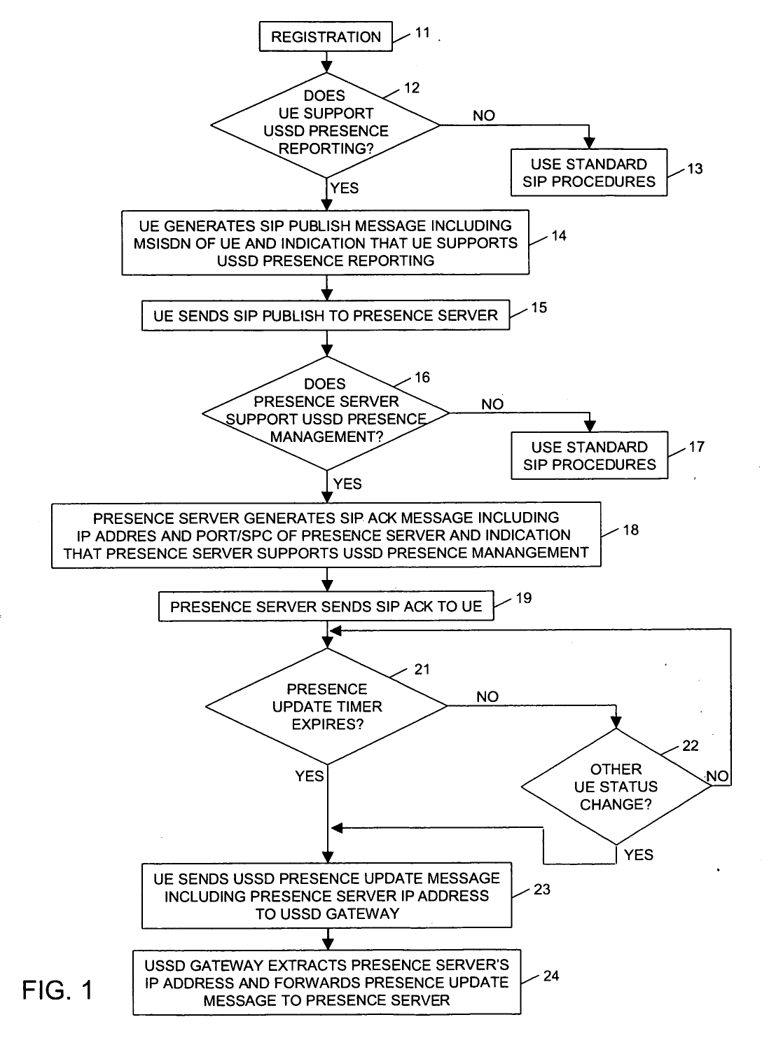

FIG. 1 is a flow chart illustrating the steps of an embodiment of the present invention in a WCDMA network. In WCDMA networks, the present invention substitutes circuit-switched USSD signaling for the “refresh” SIP PUBLISH signaling (i.e., all presence updates after the initial registration with the presence server). The initial publication (at registration) still uses the standardized SIP PUBLISH method from the UE to the presence server. Thus, at step 11, the UE begins registration with the network. At step 12, it is determined whether the UE supports USSD presence reporting. If not, the method moves to step 13 where the UE utilizes standard SIP procedures for presence reporting. However, if the UE supports USSD presence reporting, the method moves to step 14 where the UE generates an initial SIP PUBLISH message. The message includes the MSISDN of the UE together with an indication that the UE supports USSD for refreshing the presence information. The MSISDN is used for return addressing, and to identify the UE to the presence server when USSD signaling is used. At step 15, the UE sends the SIP PUBLISH message to the presence server.

At step 16, it is determined whether the presence server supports USSD presence management. If not, the method moves to step 17 where the presence server utilizes standard SIP procedures for presence management. However, if the UE supports USSD presence management, the method moves to step 18 where the presence server generates a SIP ACK message. The ACK message includes the IP address and port or SPC of the presence server together with an indication that the presence server supports USSD presence management. At step 19, the presence server sends the SIP ACK message to the UE.

As noted above, the present invention substitutes USSD signaling for all presence updates after the initial registration with the presence server. Therefore, the UE sends all refresh signaling via circuit-switched USSD messages instead of SIP. At step 21, it is determined whether a presence update timer has expired, requiring that a presence update message be sent to the presence server. If not, the method moves to step 22 where it is determined whether any other change in the presence status of the UE has occurred. If not, the method returns to step 21 and waits for the update timer to expire. If the timer expires, or another change in the presence status of the UE occurs, the method moves to step 23 where the UE sends a circuit-switched USSD presence update message to a USSD gateway (external to the HLR/HSS). The UE includes the IP address of the presence server in the update message. For example, the presence server's IP address may be included in the USSD user data. At step 24, a USSD application on the USSD gateway extracts the presence server's IP address, and uses the IP address to forward the presence update message (and subsequent update messages) to the correct presence server.

The present invention also substitutes USSD signaling for the SIP NOTIFY messages in networks where notifications are sent periodically (versus only on request by the UE). The initial SIP SUBSCRIBE/SIP NOTIFY sequence is not changed from 3GPP 24.841, except that the presence server receives the UE's MSISDN and a new indication that the UE supports the USSD presence reporting. Periodically thereafter, the presence server sends a USSD notification to the UE client, and receives an acknowledgement.

The use of the proposed method overcomes several inefficiencies in the standardized method. After PDP context establishment and registration with the PoC server (and subsequent registration with the presence server), if no PoC call is made, the traffic on the air interface drops to zero. The down-switch timer (1-10 seconds) then causes the UE to change from CELL_DCH to CELL_FACH, as the initial dedicated transport channels are replaced with common transport channels. The RNC inactivity-timer also starts and subsequently expires (default of 30 seconds). This expiration triggers the RNC to send an lu-release-request message to the core network. The core network may refuse the lu-release-request if application-layer connections exist. Normally the core network accepts, so the RRC connection, as well as the lu-PS signaling connection and RAB's are released, and the UE enters CELL_PCH state.

SIP signaling for PoC is on the primary PDP context for the session, and thus an interactive class RAB is required. If the UE is in CELL_PCH state, the presence re-registration using SIP requires that the RAB must be re-established. The RRC connection between the Radio Network Controller (RNC) and the UE is first re-established. The lu-PS signaling connection between the RNC and the MSC server is next established, and then the RAB is allocated. The USSD DTAP message, on the other hand, is sent via the signaling connection, so it is not necessary to re-establish the RAB, just the RRC connection and lu-CS signaling connection. This results in less signaling over the air-interface, and therefore less latency as well.

Another advantage of USSD signaling (versus SIP) is that the signaling does not use the IP multimedia network. The signaling is through the MSC and HLR, and then via a dedicated IP (or MAP) connection to the presence server. This also results in less latency of the presence status updates.

Note that if the presence server uses USSD signaling to update contact list information at the UE, then the UMTS Subscriber Identity Module (USIM) would also need to support application-mode signaling to the PoC client.

GSM/GPRS networks realize similar advantages from the smaller message sizes over the air interface and the reduced number of messages in the IMS nodes. GSM/GPRS Type-B MSs can monitor both circuit-switched and packet-switched control channels simultaneously, but cannot operate services on circuit-switched and packet-switched domains simultaneously. A Stand-alone Dedicated Control Channel (SDCCH) is required to deliver the circuit-switched USSD message. So when the MS is attached for GPRS operation (STANDBY state), and is paged for circuit-switched dedicated mode, the MS suspends the packet-switched GPRS service. As long as the circuit-switched connection (i.e., the SDCCH) is present, the packet-switched service remains suspended. When the circuit-switched connection is subsequently dropped, the MS performs a Routing Area Update (RAU) or combined RAU, depending upon the network operation mode (i.e., Gs interface used, etc.). The RAU enables the Serving GPRS Service Node (SGSN) to continue sending an interrupted packet flow to the MS.

For sending presence status using SIP, a Type-B MS in STANDBY state uses a Random Access Channel (RACH) request or Packet Random Access Channel (PRACH) request to send a PACKET CHANNEL REQUEST to the SGSN. The MS receives a PACKET UPLINK ASSIGNMENT from the SGSN. Upon sending the last uplink data block, the radio resources are released again.

With the USSD signaling method of the present invention, the SDCCH is allocated and used to send a USSD REGISTER message. Although there is not much difference in the number of messages sent in the RAN, the message size is much smaller, thereby significantly reducing the required bandwidth over the air interface.

An additional advantage of the USSD signaling method in a GSM network is that the USSD signaling method enables the MS to update the presence server when a circuit-switched call is initiated, on-going, and terminated. This is a useful feature, since the MS would have previously registered as “available”, but could not send an update via SIP after being paged for a circuit-switched call. Therefore the MS would be “available” to the presence server, while the MS is actually “not available” due to the current circuit-switched call.

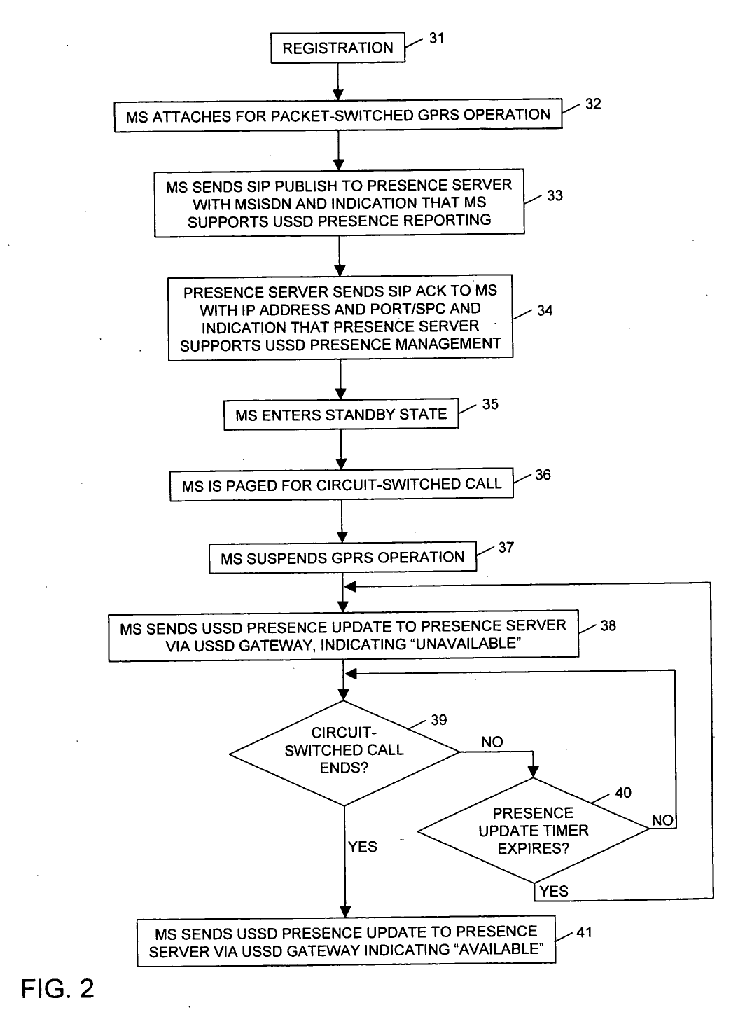

FIG. 2 is a flow chart illustrating the steps of a method of sending presence updates when an MS attached for GPRS operation is paged for a circuit-switched call. At step 31, the MS begins registration with a GPRS network. At step 32, the MS attaches for packet-switched GPRS operation. At step 33, the MS sends a SIP PUBLISH message to the presence server with the MSISDN of the MS and an indication that the MS supports USSD presence reporting. At step 34, the presence server sends a SIP ACK message to the MS with the IP address and port or SPC of the presence server, and an indication that the presence server supports USSD presence management.

At some later time, as shown at step 35, the MS enters the STANDBY state. Thereafter, at step 36, the MS is paged for a circuit-switched call. At step 37, the MS suspends packet-switched GPRS operation to respond to the page and take the circuit-switched call. At step 38, the MS sends a circuit-switched USSD presence update message to the presence server via the USSD gateway. The update message indicates that the MS is “unavailable”. At step 39, it is determined whether the circuit-switched call ends. If not, the method moves to step 40 where it is determined whether a presence update timer expires. If not, the method returns to step 39 and waits for either the circuit-switched call to end or the presence timer to expire, whichever occurs first. If the presence update timer expires first, the method returns to step 38 where the MS sends a circuit-switched USSD presence update message to the presence server indicating that the MS is still “unavailable”. However, if the circuit-switched call ends first, the method moves to step 41 where the MS sends a circuit-switched USSD presence update message to the presence server, via the USSD gateway, indicating that the MS is now “available”.

The present invention may of course, be carried out in other specific ways than those set forth herein without departing from the essential characteristics of the invention. The described embodiments are, therefore, to be considered in all respects as illustrative and not restrictive and all changes coming within the meaning and equivalency range of the appended claims are intended to be embraced therein.

What is claimed is:

1. A method of managing presence information in a packet-switched wireless communication network, said method comprising:
sending a circuit-switched presence update message from a mobile unit to a presence server in the packet-switched network; and
updating the presence information for the mobile unit in the presence server.

2. The method of claim 1, wherein the mobile unit is a User Equipment (UE) operating in a Wideband Code Division Multiple Access (WCDMA) network.

3. The method of claim 1, wherein the mobile unit is a Mobile Station (MS) operating in a General Packet Radio Service (GPRS) network.

4. The method of claim 1, wherein the step of sending a circuit-switched presence update message includes sending an Unstructured Supplementary Services Data (USSD) message from the mobile unit to the presence server.

5. The method of claim 4, wherein the step of sending a USSD message from the mobile unit to the presence server includes:
placing an Internet Protocol (IP) address of the presence server in the USSD message;
sending the USSD message to a USSD gateway;
extracting the IP address of the presence server from the USSD message by the USSD gateway; and
forwarding the presence update message to the presence server utilizing the extracted IP address of the presence server.

6. The method of claim 4, further comprising, prior to sending the USSD message from the mobile unit to the presence server, the step of determining by the mobile unit that a change in the presence status of the mobile unit has occurred.

7. A method of managing presence information in a packet-switched wireless communication network, said method comprising:
sending a packet-switched presence message from a mobile unit to a presence server in the packet-switched network during initial registration of the mobile unit with the packet-switched wireless communication network, said packet-switched presence message including presence information for the mobile unit, an identification number for the mobile unit, and an indication that the mobile unit supports circuit-switched presence reporting;
sending a packet-switched acknowledgment message from the presence server to the mobile unit in response to the packet-switched presence message, said packet-switched acknowledgment message including an Internet Protocol (IP) address of the presence server and an indication that the presence server supports circuit-switched presence management;
thereafter, determining by the mobile unit that a change in the presence status of the mobile unit has occurred;
sending a circuit-switched presence update message from the mobile unit to the presence server; and
updating the presence information for the mobile unit in the presence server.

8. The method of claim 7, wherein the mobile unit is a User Equipment (UE) operating in a Wideband Code Division Multiple Access (WCDMA) network.

9. The method of claim 7, wherein the mobile unit is a Mobile Station (MS) operating in a General Packet Radio Service (GPRS) network.

10. The method of claim 7, wherein the step of sending a circuit-switched presence update message includes sending an Unstructured Supplementary Services Data (USSD) message from the mobile unit to the presence server.

11. The method of claim 10, wherein the step of sending a USSD message from the mobile unit to the presence server includes:
placing the IP address of the presence server in the USSD message;
sending the USSD message to a USSD gateway;
extracting the IP address of the presence server from the USSD message by the USSD gateway; and
forwarding the presence update message to the presence server utilizing the extracted IP address of the presence server.

12. An Unstructured Supplementary Services Data (USSD) gateway comprising:
means for receiving a circuit-switched USSD presence update message from a mobile unit, said USSD presence update message including an Internet Protocol (IP) address of a presence server in a packet-switched wireless communications network;
means for extracting the IP address of the presence server from the USSD message; and
means for forwarding the presence update message to the presence server utilizing the extracted IP address of the presence server.

13. A method of reporting presence information for a mobile station attached for packet-switched operation in a General Packet Radio Service (GPRS) wireless communication network, wherein the mobile station has entered a STANDBY state, said method comprising:
receiving by the mobile station, a page for a circuit-switched call;
suspending packet-switched GPRS operation by the mobile station; and
sending a circuit-switched presence update message from the mobile station to a presence server in the GPRS network, said circuit-switched presence update message including an indication that the mobile station is unavailable.

14. The method of claim 13, wherein the step of sending a circuit-switched presence update message includes sending an Unstructured Supplementary Services Data (USSD) message from the mobile station to the presence server.

15. The method of claim 14, wherein the step of sending a USSD message from the mobile station to the presence server includes:
placing the IP address of the presence server in the USSD message;
sending the USSD message to a USSD gateway;
extracting the IP address of the presence server from the USSD message by the USSD gateway; and
forwarding the presence update message to the presence server utilizing the extracted IP address of the presence server.

16. The method of claim 15, wherein the step of sending a USSD message from the mobile station to the presence server also includes placing the mobile station's Mobile Station Integrated Services Digital Network (MSISDN) number in the USSD message to identify the mobile station to the presence server.

17. The method of claim 16, further comprising:
periodically sending refresh USSD messages from the mobile station to the presence server during the circuit-switched call, said refresh USSD messages including an indication that the mobile station is still unavailable.

18. The method of claim 16, further comprising:
ending the circuit-switched call by the mobile station; and
sending a second USSD message from the mobile station to the presence server, said second USSD message including an indication that the mobile station is available.
